(19) United States
(12) Patent Application Publication
(10) Pub. No.: US 2011/0154008 A1
(43) Pub. Date: Jun. 23, 2011

(54) ELECTRONIC DEVICE AND METHOD FOR BOOTING UP AND SHUTTING DOWN THE ELECTRONIC DEVICE

(75) Inventors: YUH-HUNG WENG, Tu-Cheng (TW); CHEN-HUANG FAN, Tu-Cheng (TW)

(73) Assignee: HON HAI PRECISION INDUSTRY CO., LTD., Tu-Cheng (TW)

(21) Appl. No.: 12/837,479

(22) Filed: Jul. 15, 2010

(30) Foreign Application Priority Data
Dec. 22, 2009 (CN) 200910312023.5

(51) Int. Cl. G06F 9/00

(52) U.S. Cl. 713/2; 713/300

(57) ABSTRACT

A method for booting up and shutting down an electronic device is applied in the electronic device. The electronic device includes a processor, a first storage, and a second storage. The speed of the processor accessing data from the first storage is faster than the speed of the processor accessing data from the second storage. The second storage stores the boot data for booting up the electronic device. The method includes: receiving signals for booting up the electronic device; detecting whether the first storage stores the boot data; and obtaining the boot data from the first storage to boot up the electronic device if the first storage stores the boot data. A related electronic device is also provided.

### BACKGROUND

1. Technical Field

The present disclosure relates to electronic devices and, particularly, to an electronic device with a function of booting up and a method for booting up and shutting down the electronic device.

2. Description of Related Art

Portable electronic devices, for example, mobile phones, usually include a Random Access Memory (RAM) and a flash memory. The boot data for booting up a portable electronic device are stored in the flash memory. The speed of a portable electronic device accessing data from the RAM is faster than the speed of the portable electronic device accessing data from the flash memory. Therefore, to increase the speed of booting up the portable electronic device, the portable electronic device obtains the boot data from the flash memory, stores the boot data in the RAM, and then obtains the boot data from the RAM for the boot up procedure. However, the process of obtaining the boot data from the flash memory and storing the boot data in the RAM still consumes time. Therefore, the speed of booting up the electronic device is still slow.

### BRIEF DESCRIPTION OF THE DRAWINGS

The components of the drawings are not necessarily drawn to scale, the emphasis instead being placed upon clearly illustrating the principles of an electronic device and a method for booting up and shutting down the electronic device. Moreover, in the drawings, like reference numerals designate corresponding parts throughout several views.

FIG. 1 is a block diagram of an electronic device in accordance with an exemplary embodiment.

FIG. 2 is a flowchart of a method for booting up and shutting down the electronic device of FIG. 1 in accordance with an exemplary embodiment.

### DETAILED DESCRIPTION

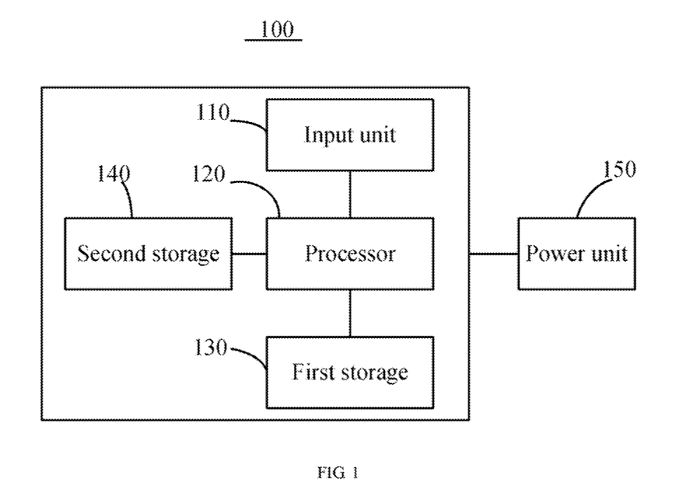

Referring to FIG. 1, an electronic device 100 includes an input unit 110, a processor 120, a first storage 130, a second storage 140, and a power unit 150. The electronic device 100 can be a mobile phone or a PDA.

The input unit 110 is configured to generate signals for signaling the processor 120 to boot up and shut down the electronic device 100 in response to user input.

In this embodiment, the speed of the processor 120 accessing data from the first storage 130 is faster than the speed of the processor 120 accessing data from the second storage 140. The first storage 130 may be a Static Random Access Memory (SRAM), and the second storage 140 may be a flash memory. The second storage 140 stores boot data for booting up the electronic device 100.

In this embodiment, when receiving the signals for the first time for booting up the electronic device 100, the processor 120 obtains the boot data from the second storage 140 and stores the boot data in the first storage 130. The processor 120 then obtains the boot data from the first storage 130 to boot up the electronic device 100. After the electronic device 100 is booted up, the processor 120 erases the boot data from the first storage 130, thus the first storage 130 can provide enough space to store data from the processor 120 during the operation of the electronic device 100. When receiving the signals for the first time for shutting down the electronic device 100, the processor 120 again stores the boot data in the first storage 130.

The power unit 150 is configured to provide power to the electronic device 100. In this embodiment after the electronic device 100 is shut down, the power unit 150 continues to provide power to the first storage 130, thus the boot data in the first storage 130 cannot be erased when the electronic device 100 is shut down.

With such configuration, when receiving the signals for booting up the electronic device 100 next time, the processor 120 can directly obtain the boot data from the first storage 130 to boot up the electronic device 100. Because the first storage 130 has a faster data access rate than the second storage 140, the speed of booting up the electronic device 100 increases.

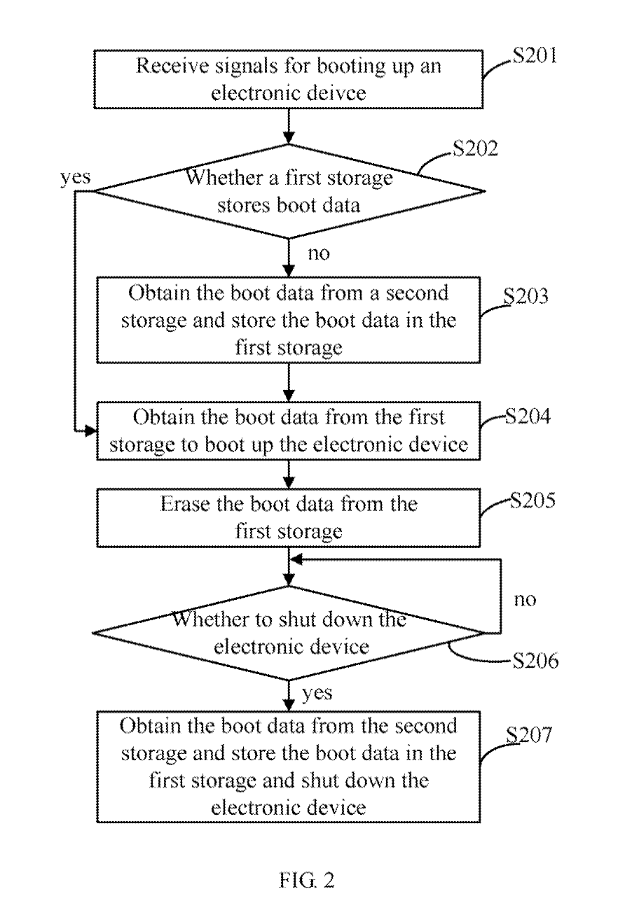

FIG. 2 is a flowchart of a method for booting up and shutting down the electronic device 100.

In step S201, the processor 120 receives the signals for booting up the electronic device 100.

In step S202, the processor 120 detects whether the first storage 130 stores the boot data. If no, the procedure goes to step S203, otherwise the procedure goes to step S204.

In step S203, the processor 120 obtains the boot data from the second storage 140 and stores the boot data in the first storage 130.

In step S204, the processor 120 obtains the boot data from the first storage 130 to boot up the electronic device 100.

In step S205, the processor 120 erases the boot data from the first storage 130.

In step S206, the processor 120 detects whether the signals for shutting down the electronic device 100 is received. If the processor 120 receives the signals for shutting down the electronic device 100, the procedure goes to step S207, otherwise the procedure continues to execute the step S206.

In step S207, the processor 120 obtains the boot data from the second storage 140, stores the boot data in the first storage 130, and shuts down the electronic device 100. After the electronic device 100 has been shut down, the power unit 150 continues to provide power to the first storage 130.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device, comprising:
a processor;
an input unit configured for generating signals for signaling the processor to boot up and shut down the electronic device;
a first storage; and
a second storage storing boot data for booting up the electronic device, the speed of the processor accessing data from the first storage being faster than the speed of the processor accessing data from the second storage;
the processor being configured for detecting whether the first storage stores the boot data when the processor receives the signals for booting up the electronic device, and obtaining the boot data from the first storage to boot up the electronic device if the first storage stores the boot data.

2. The electronic device as described in claim 1, wherein the processor is further configured for obtaining the boot data from the second storage and storing the boot data in the first storage if the first storage does not store the boot data, and configured for obtaining the boot data from the first storage to boot up the electronic device.

3. The electronic device as described in claim 2, wherein the processor is further configured for erasing the boot data from the first storage after the electronic device is booted up.

4. The electronic device as described in claim 3, wherein the processor is further configured for obtaining the boot data from the second storage and storing the boot data in the first storage when the processor receives the signals for shutting down the electronic device.

5. The electronic device as described in claim 4, further comprising a power unit configured for providing power to the first storage after the electronic device is shut down.

6. The electronic device as described in claim 1, wherein the first storage is a Static Random Access Memory, and the second storage is a flash memory.

7. A method for booting up and shutting down an electronic device applied in the electronic device, the electronic device comprising a processor, a first storage, and a second storage, the speed of the processor accessing data from the first storage being faster than the speed of the processor accessing data from the second storage, the second storage storing the boot data for booting up the electronic device, the method comprising:
receiving signals for booting up the electronic device;
detecting whether the first storage stores the boot data; and
obtaining the boot data from the first storage to boot up the electronic device if the first storage stores the boot data.

8. The method as described in claim 7, further comprising:
obtaining the boot data from the second storage and storing the boot data in the first storage if the first storage does not store the boot data; and
obtaining the boot data from the first storage to boot up the electronic device.

9. The method as described in claim 8, further comprising:
erasing the boot data from the first storage after booting up the electronic device.

10. The method as described in claim 9, further comprising:
obtaining the boot data from the second storage and storing the boot data in the first storage when signals for shutting down the electronic device is received.

11. The method as described in claim 10, further comprising:
providing power to the first storage after the electronic device is shut down.

12. The method as described in claim 7, wherein the first storage is a Static Random Access Memory, and the second storage is a flash memory.
